(19) United States
(12) Patent Application Publication
(10) Pub. No.: US 2009/0037399 A1
(43) Pub. Date: Feb. 5, 2009

(54) System and Method for Determining Semantically Related Terms

(75) Inventors: Kevin Bartz, San Francisco, CA (US); Vijay Murthi, Milpitas, CA (US); Shaji Sebastian, Pasadena, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/831,311

(22) Filed: Jul. 31, 2007

(51) Int. Cl. G06F 17/30

(52) U.S. Cl. 707/5; 707/E17.107

(57) ABSTRACT

Systems and methods for determining semantically related terms are disclosed. Generally, a semantically related term tool trains a model to predict a degree of relevance between a candidate term and one or more seed terms. The model may be trained based on data such as a plurality of seed sets, a plurality of semantically related term sets, and a plurality of modular optimized dynamic sets (“MODS”), where each semantically related term set is related to a seed set of the plurality of seed sets and each MODS is related to a seed set of the plurality of seed sets. The semantically related term tool then determines a plurality of terms that are semantically related to one or more terms in a new seed set based on the model, the one or more terms in the seed set, and a plurality of candidate terms.

### BACKGROUND

When advertising using an online advertisement service provider such as Yahoo! Search Marketing™, or performing a search using an Internet search engine such as Yahoo!™, users often wish to determine semantically related terms. Two terms, such as words or phrases, are semantically related if the terms are related in meaning in a language or in logic. Obtaining semantically related terms allows advertisers to broaden or focus their online advertisements to relevant potential customers and allows searchers to broaden or focus their Internet searches in order to obtain more relevant search results.

Various systems and methods for determining semantically related terms are disclosed in U.S. patent application Ser. Nos. 11/432,266 and 11/432,585, filed May 11, 2006 and assigned to Yahoo! Inc. For example, in some implementations in accordance with U.S. patent application Ser. Nos. 11/432,266 and 11/432,585, a system determines semantically related terms based on web pages that advertisers have associated with various terms during interaction with an advertisement campaign management system of an online advertisement service provider. In other implementations in accordance with U.S. patent application Ser. Nos. 11/432,266 and 11/432,585, a system determines semantically related terms based on terms received at a search engine and a number of times one or more searchers clicked on particular universal resource locators (“URLs”) after searching for the received terms.

Yet other systems and methods for determining semantically related terms are disclosed in U.S. patent application Ser. No. 11/600,698, filed Nov. 16, 2006, and assigned to Yahoo! Inc. For example, in some implementations in accordance with U.S. patent application Ser. No. 11/600,698, a system determines semantically related terms based on sequences of search queries received at an Internet search engine that are related to similar concepts.

It would be desirable to develop additional systems and methods for determining semantically related terms based on other sources of data.

### BRIEF DESCRIPTION OF THE DRAWINGS

FIG. 1 is a block diagram of one embodiment of an environment in which a system for determining semantically related terms may operate;

FIG. 2 is a block diagram of one embodiment of a system for determining semantically related terms; and

FIG. 3 is a flow chart of one embodiment of a method for determining semantically related terms.

### DETAILED DESCRIPTION OF THE DRAWINGS

The present disclosure is directed to systems and methods for determining semantically related terms. An online advertisement service provider (“ad provider”) may desire to determine semantically related terms to suggest new terms to online advertisers so that the advertisers can better focus or expand delivery of advertisements to potential customers. Similarly, a search engine may desire to determine semantically related terms to assist a searcher performing research at the search engine. Providing a searcher with semantically related terms allows the searcher to broaden or focus a search so that search engines provide more relevant search results to the searcher.

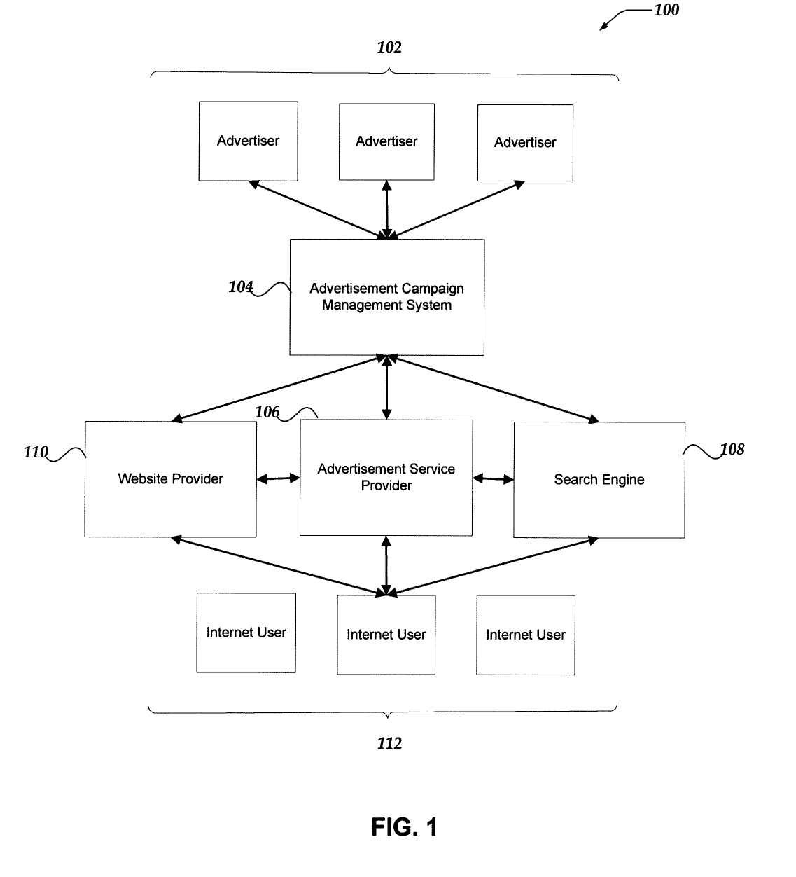

FIG. 1 is a block diagram of one embodiment of an environment in which a system for determining semantically related terms may operate. However, it should be appreciated that the systems and methods described below are not limited to use with a search engine or pay-for-placement online advertising.

The environment 100 may include a plurality of advertisers 102, an ad campaign management system 104, an ad provider 106, a search engine 108, a website provider 110, and a plurality of Internet users 112. Generally, an advertiser 102 bids on terms and creates one or more digital ads by interacting with the ad campaign management system 104 in communication with the ad provider 106. The advertisers 102 may purchase digital ads based on an auction model of buying ad space or a guaranteed delivery model by which an advertiser pays a minimum cost-per-thousand impressions (i.e., CPM) to display the digital ad. Typically, the advertisers 102 may pay additional premiums for certain targeting options, such as targeting by demographics, geography, technographics or context. The digital ad may be a graphical banner ad that appears on a website viewed by Internet users 112, a sponsored search listing that is served to an Internet user 112 in response to a search performed at a search engine, a video ad, a graphical banner ad based on a sponsored search listing, and/or any other type of online marketing media known in the art.

When an Internet user 112 performs a search at a search engine 108, the search engine 108 may return a plurality of search listings to the Internet user. The ad provider 106 may additionally serve one or more digital ads to the Internet user 112 based on search terms provided by the Internet user 112. In addition or alternatively, when an Internet user 112 views a website served by the website provider 110, the ad provider 106 may serve one or more digital ads to the Internet user 112 based on keywords obtained from the content of the website.

When the search listings and digital ads are served, the ad campaign management system 104, the ad provider 106, and/or the search engine 108 may record and process information associated with the served search listings and digital ads for purposes such as billing, reporting, or ad campaign optimization. For example, the ad campaign management system 104, ad provider 106, and/or search engine 108 may record the search terms that caused the search engine 108 to serve the search listings; the search terms that caused the ad provider 106 to serve the digital ads; whether the Internet user 112 clicked on a URL associated with one of the search listings or digital ads; what additional search listings or digital ads were served with each search listing or each digital ad; a rank of a search listing when the Internet user 112 clicked on the search listing; a rank or position of a digital ad when the Internet user 112 clicked on a digital ad; and/or whether the Internet user 112 clicked on a different search listing or digital ad when a digital ad, or a search listing, was served. One example of an ad campaign management system that may perform these types of actions is disclosed in U.S. patent application Ser. No. 11/413,514, filed Apr. 28, 2006, and assigned to Yahoo! Inc., the entirety of which is hereby incorporated by reference. It will be appreciated that the systems and methods for determining semantically related terms described below may operate in the environment of FIG. 1.

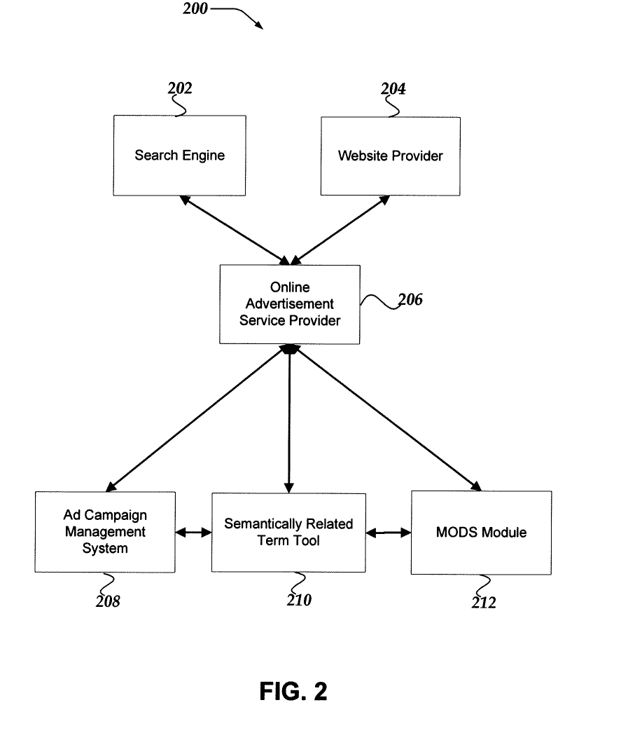

FIG. 2 is a block diagram of one embodiment of a system for determining semantically related terms. The system 200 may include a search engine 202, a website provider 204, an ad provider 206, an advertisement campaign management system 208, a semantically related term tool 210, and a modular optimized dynamic sets (“MODS”) module 212. In some implementations, the ad campaign management system 208, semantically related term tool 210, and/or MODS module 212 may be part of the search engine 202, website provider 204, and/or ad provider 206. However, in other implementations, the ad campaign management system 208, semantically related term tool 210, and/or MODS module 212 are distinct from the search engine 202, website provider 204, and/or ad provider 206.

The search engine 202, website provider 204, ad provider 206, ad campaign management system 208, semantically related term tool 210, and MODS module 212 may communicate with each other over one or more external or internal networks. The networks may include local area networks (LAN), wide area networks (WAN), and the Internet, and may be implemented with wireless or wired communication mediums such as wireless fidelity (WiFi), Bluetooth, landlines, satellites, and/or cellular communications. Further, the search engine 202, website provider 204, ad provider 206, ad campaign management system 208, semantically related term tool 210, and MODS module 212 may be implemented as software code running in conjunction with a processor such as a single server, a plurality of servers, or any other type of computing device known in the art.

As described in more detail below, the search engine 202, ad provider 206, and/or ad campaign management system 208 receives a seed set including one or more seed terms. Generally, the seed set represents the type of terms for which the user or system submitting the seed set would like to receive additional terms having a similar meaning in logic or in a language. The semantically related term tool 210 determines a first plurality of terms that are semantically related to the seed set. Additionally, the MODS module 212 determines a second plurality of terms that are modular optimized dynamic sets of terms of the seed set as taught in U.S. patent application Ser. No. 11/600,603. At least a portion of the first plurality of terms and at least a portion of the second plurality of terms are presented to a user, who indicates a degree of relevance between the presented terms and the seed set. It will be appreciated that at least a portion of a plurality of terms should be interpreted to mean one, some or all of the respective plurality of terms. The above-described process is repeated for multiple seed sets and the semantically related term tool 210 trains a model based on the seed sets, terms presented to the user, and the indicated degrees of relevance. Once the model is trained, the semantically related term tool 210 may use the model to predict a degree of relevance between a newly received seed set and a plurality of candidate terms associated with the newly received seed set. Based on the predicted degree of relevance, the semantically related term tool may suggest terms that are semantically related to the newly received seed set or export semantically related terms to the search engine 202 or ad provider 206 for purposes such as query expansion or ad campaign optimization.

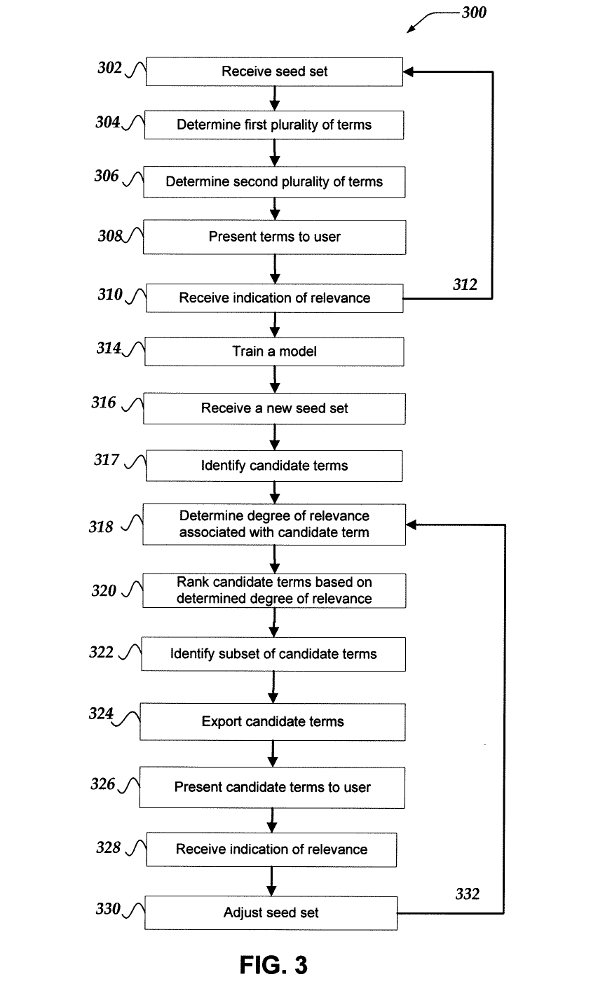

FIG. 3 is a flow chart of one embodiment of a method for determining semantically related terms. The method 300 begins with the search engine, ad provider and/or ad campaign management system receiving a seed set including one or more seed terms at step 302. Each seed term may be a positive seed term or a negative seed term. In one implementation, a positive seed term is a term that represents the type of keywords an advertiser would like to bid on to have the ad provider serve a digital ad, and a negative seed term is a term that represents the type of keyword an advertiser would not like to bid on to have the ad provider serve a digital ad. In other words, an advertiser may use a semantically related term tool, also known as a keyword suggestion tool, to receive more keywords like a positive seed term, while avoiding keywords like a negative seed term. The seed set may be received at step 302 from an advertiser interacting with an ad campaign management system, from an Internet user submitting a search to an Internet search engine, from the content of a webpage, or in any other manner known in the art.

At step 304, the semantically related term tool determines a first plurality of terms that are semantically related to the seed set based on factors such as web pages that advertisers have associated with various terms during interaction with an ad campaign management system; terms received at an Internet search engine and a number of times one or more Internet users clicked on particular universal resource locators (“URLs”) after searching for the received terms; sequences of search queries received at a search engine that are related to similar concepts; and/or concept terms within search queries received at a search engine. Examples of semantically related term tools that may determine a plurality of terms that are semantically related to a seed set based on factors such as the above-described factors are disclosed in U.S. Pat. No. 6,269,361, issued Jul. 31, 2006; U.S. Pat. No. 7,225,182, issued May 29, 2007; U.S. patent application Ser. No. 11/432,266, filed May 11, 2006; U.S. patent application Ser. No. 11/432,585, filed May 11, 2006; U.S. patent application Ser. No. 11/600,698, filed Nov. 16, 2006; U.S. patent application Ser. No. 11/731,396, filed Mar. 30, 2007; and U.S. patent application Ser. No. 11/731,502, filed Mar. 30, 2007, each of which are assigned to Yahoo! Inc. and the entirety of each of which are hereby incorporated by reference.

At step 306, the MODS module determines a second plurality of terms that are modular optimized dynamic sets of terms of the seed set. Examples of MODS modules are described in U.S. patent application Ser. No. 11/600,603, titled “System and Method for Generating Substitutable Queries on the Basis of One or More Features,” filed Nov. 15, 2006 and assigned to Yahoo! Inc., the entirety of which is hereby incorporated by reference. Generally, modular optimized dynamic sets are two or more search queries that can be substituted for each other while still retaining the same meaning in an advertising system of an online advertisement service provider. For example in one implementation, two or more search queries are modular optimized dynamic sets if the search queries may be substituted for each other while still resulting in substantially similar search results. Therefore, as described in U.S. patent application Ser. No. 11/600,603, the MODS module may determine a plurality of terms that may be substituted for the seed terms of the seed set while still maintaining the same meaning.

At least a portion of the first plurality of terms and at least a portion of the second plurality of terms are presented to a user at step 308. In some implementations the user may be an advertiser interacting with the semantically related term tool or an employee of the ad provider interacting with the semantically related term tool. At step 310, the semantically related term tool receives an indication of relevance for at least a portion of the terms presented at step 308. In some implementations the user may label a presented term as relevant or not relevant, where in other implementations, the user may indicate a degree of relevance on a scale, such as a scale of zero to ten.

Steps 302 through 310 are repeated for multiple seed sets (loop 312) until at step 314, the semantically related term tool trains a model to predict a degree of relevance between a candidate term and one or more seed terms. The semantically related term tools train the model based on data such as the seed sets received at step 302, the pluralities of terms created by the semantically related term tool at step 304, the pluralities of terms created by the MODS module at step 306, and the indications of relevance received at step 310. In some implementations, the model is trained using a logistic regression model and factors such as an edit distance between a term and one or more terms in a seed set; a word edit distance between a term and one or more terms in a seed set; a prefix overlap between a term and one or more terms in a seed set; a suffix overlap between a term and one or more terms in a seed set; whether a term was identified by the semantically related term tool; whether a term was identified by the MODS module; whether a term is a domain name; a number of seed terms in a seed set; a number of characters in the seed set; a query substitution log-likelihood between a term identified by the MODS module and one or more terms of a seed set; a degree of search overlap between a term and one or more terms in the seed set; a relevance score of a term as calculated by a keyword suggestion tool or a MODS module; or any other property or metric that indicates a degree of semantical relationship between a term and one or more terms in a seed set.

Generally, an edit distance, also known as Levenshtein distance, is the smallest number of inserts, deletions, and substitutions of characters needed to change a semantically related term into one or more terms of the seed set, and word edit distance is the smallest number of insertions, deletions, and substitutions of words needed to change a semantically related term into one or more terms of the seed set. A degree of search overlap between a semantically related term and one or more terms of the seed set is a degree of similarity of search results resulting from a search at an Internet search engine for a semantically related term and a search at the Internet search engine for one or more terms of the seed set. Prefix overlap occurs between two terms when one or more words occur at the beginning of both terms. For example, the terms “Chicago Bears” and “Chicago Cubs” have a prefix overlap due to the fact the word “Chicago” occurs at the beginning of both terms. Similarly, suffix overlap occurs between two terms when one or more words occur at the end of both terms. For example, the terms “San Francisco Giants” and “New York Giants” have a suffix overlap due to the fact the word “Giants” occurs at the end of the both terms.

After creating the model, the semantically related term tool receives a new seed set including one or more seed terms at step 316. The semantically related term tool then identifies a new plurality of candidate terms associated with the one or more seed terms at step 317. In one implementation, the semantically related term tool may identify candidate terms at step 317 by identifying one or more terms from one or both of modular optimized dynamic sets of the seed terms received from a MODS module and semantically related terms that are determined based on keyword suggestion algorithms such as those described in U.S. Pat. No. 6,269,361, U.S. Pat. No. 7,225,182, U.S. patent application Ser. No. 11/432,266, U.S. patent application Ser. No. 11/432,585, U.S. patent application Ser. No. 11/600,698, U.S. patent application Ser. No. 11/731,396, and U.S. patent application Ser. No. 11/731,502. In other words, to identify candidate terms at step 317, the semantically related term tool may identify candidate terms across multiple sources of data, each of which include terms that are determined to be related to the seed set. It should be appreciate that the semantically related term tool may identify candidate terms associated with seed terms using keyword suggestion algorithms other than those described above, and/or the semantically related term tool may receive candidate terms related to seed terms from sources of data other than those described above.

Using the model, at step 318 the semantically related term tool determines a degree of relevance between each term of the plurality of candidate terms identified at step 317 and the seed terms of the new seed set. In some implementations, at step 320 the semantically related term tool may rank the terms of the plurality of candidate terms based on the determined degree of relevance of each term to the seed terms of the new seed set.

The semantically related term tool identifies a subset of the candidate terms at step 322 that are closely related to the seed set received at step 316 based on the determined degrees of relevance. By identifying the subset of the candidate terms that are closely related to the seed set, the semantically related term tool identifies the terms that are the most closely related to the seed set across the multiple sources of data used to create the plurality of candidate terms at step 317. In one implementation, the semantically related term tool may identify a number of terms, such as the top ten terms, that have the highest determined degrees of relevance. In other implementations, the semantically related term tool may identify the terms with a determined degree of relevance above a predetermined threshold.

At step 324, before the method 300 ends at least a portion of the subset of the plurality of candidate terms may be exported to an Internet search engine or online advertisement service provider for purposes such as query expansion or ad campaign optimization. In addition or alternatively, at step 326, before the method 300 ends at least a portion of the subset of the plurality of candidate terms may be presented to an advertiser or user interacting with the semantically related term tool or an ad campaign management system.

In implementations where at least a portion of the subset of the plurality of candidate terms are presented to an advertiser or user interacting with the semantically related term tool or an ad campaign management system, at step 328 the semantically related term tool may receive indications of relevance of at least a portion of the presented terms to the seed terms. In some implementations the advertiser or user may label a presented term as relevant or not relevant, where in other implementations, the advertiser or user may indicate a degree of relevance on a scale, such as a scale of zero to ten.

Based on the received degrees of relevance, at step 330 the seed set is adjusted and the method loops (loop 332) to step 318 where the above-described process is repeated until the advertiser or user does not desire additional semantically related terms and the method ends. In some implementations, the seed set is adjusted by removing terms from the seed set that are associated with terms the user has indicated are not relevant and/or adding terms to the seed set that are associated with terms the use has indicated are relevant.

FIGS. 1-3 disclose systems and methods for determining terms semantically related to a seed set. As described above, these systems and methods may be implemented for uses such as discovering semantically related words for purposes of bidding on online advertisements or to assist a searcher performing research at an Internet search engine.

With respect to assisting a searcher performing research at an Internet search engine, a searcher may send one or more terms, or one or more sequences of terms, to a search engine. The search engine may use the received terms as seed terms and suggest semantically related words related to the terms either with the search results generated in response to the received terms, or independent of any search results. Providing the searcher with semantically related terms allows the searcher to broaden or focus any further searches so that the search engine provides more relevant search results to the searcher.

With respect to online advertisements, in addition to providing terms to an advertiser in a keyword suggestion tool, an online advertisement service provider may use the disclosed systems and methods in a campaign optimizer component to determine semantically related terms to match advertisements to terms received from a search engine or terms extracted from the content of a webpage or news articles, also known as content match. Using semantically related terms allows an online advertisement service provider to serve an advertisement if the term that an advertiser bids on is semantically related to a term sent to a search engine rather than only serving an advertisement when a term sent to a search engine exactly matches a term that an advertiser has bid on. Providing the ability to serve an advertisement based on semantically related terms when authorized by an advertiser provides increased relevance and efficiency to an advertiser so that an advertiser does not need to determine every possible word combination for which the advertiser's advertisement is served to a potential customer. Further, using semantically related terms allows an online advertisement service provider to suggest more precise terms to an advertiser by clustering terms related to an advertiser, and then expanding each individual concept based on semantically related terms.

An online advertisement service provider may additionally use semantically related terms to map advertisements or search listings directly to a sequence of search queries received at an online advertisement service provider or a search engine. For example, an online advertisement service provider may determine terms that are semantically related to a seed set including two or more search queries in a sequence of search queries. The online advertisement service provider then uses the determined semantically related terms to map an advertisement or search listing to the sequence of search queries.

It is therefore intended that the foregoing detailed description be regarded as illustrative rather than limiting, and that it be understood that it is the following claims, including all equivalents, that are intended to define the spirit and scope of this invention.

1. A method for determining semantically related terms, the method comprising:
training a model to predict a degree of relevance between a candidate term and one or more seed terms, wherein the model is trained based on a plurality of seed sets, a plurality of semantically related term sets, and a plurality of modular optimized dynamic sets (“MODS”), and wherein each semantically related term set is related to a seed set of the plurality of seed sets and each MODS is related to a seed set of the plurality of seed sets; and
determining a plurality of terms that are semantically related to one or more terms in a seed set based on the model, the one or more terms in the seed set, and a plurality of candidate terms.

2. The method of claim 1, wherein a semantically related term tool creates the plurality of semantically related terms sets based on the plurality of seed sets.

3. The method of claim 1, wherein a MODS module creates the plurality of MODS based on the plurality of seed sets.

4. The method of claim 1, wherein the terms in the seed set are received from one of an Internet search engine, an online advertisement service provider, and a website provider.

5. The method of claim 1, further comprising:
suggesting at least one term of the plurality of terms to a user.

6. The method of claim 1, further comprising:
exporting at least one term of the plurality of terms to one of an online advertisement service provider and an Internet search engine.

7. The method of claim 1, wherein determining a plurality of terms that are semantically related to one or more terms in a seed set comprises:
for each candidate term of the plurality of candidate terms, determining a degree of relevance between the candidate term and the one or more terms of the seed set based on the model; and
identifying a subset of the plurality of candidate terms based on the determined degrees of relevance.

8. The method of claim 7, wherein identifying the subset comprises:
identifying candidate terms of the plurality of candidate terms associated with a determined degree of relevance above a predetermined threshold.

9. The method of claim 7, wherein identifying the subset comprises:
identifying a number of terms with the largest determined degrees of relevance.

10. A computer-readable storage medium comprising a set of instructions for determining semantically related terms, the set of instructions to direct a processor to perform acts of:
training a model to predict a degree of relevance between a candidate term and one or more seed terms, wherein the model is trained based on a plurality of seed sets, a plurality of semantically related term sets, and a plurality of modular optimized dynamic sets (“MODS”), and wherein each semantically related term set is related to a seed set of the plurality of seed sets and each MODS is related to a seed set of the plurality of seed sets; and
determining a plurality of terms that are semantically related to one or more terms in a seed set based on the model, the one or more terms in the seed set, and a plurality of candidate terms.

11. The computer-readable storage medium of claim 10, wherein determining a plurality of terms that are semantically to one or more terms in a seed set comprises:
for each candidate term of the plurality of candidate terms, determining a degree of relevance between the candidate term and the one or more terms of the seed set based on the model; and
identifying a subset of the plurality of candidate terms based on the determined degrees of relevance.

12. The computer-readable storage medium of claim 11, wherein identifying the subset comprises:
identifying candidate terms of the plurality of candidate terms associated with a determined degree of relevance above a predetermined threshold.

13. The computer-readable storage medium of claim 11, wherein identifying the subset comprises:
identifying a number of terms with the largest determined degrees of relevance.

14. A system for determining semantically related terms, the system comprising:
a semantically related term tool operative to train a model to predict a degree of relevance between a candidate term and one or more seed terms, and to determine a plurality of terms that are semantically related to one or more terms in a seed set based on the model, the one or more terms of the seed set, and a plurality of candidate terms;
wherein the semantically related term tool trains the model based on a plurality of seed sets, a plurality of semantically related term sets, and a plurality of modular optimized dynamic sets (“MODS”), and wherein each semantically related term set is related to a seed set of the plurality of seed sets and each MODS is related to a seed set of the plurality of seed sets.

15. The system of claim 14, wherein the semantically related term tool is further operative to identify candidate terms of the plurality of candidate terms associated with a determined degree of relevance above a predetermined threshold.

16. The system of claim 14, wherein the semantically related term tool is further operative to identify a number of terms with the largest determined degrees of relevance.

17. The system of claim 14, wherein the semantically related term tool is further operative to suggest at least a portion of the determined plurality of terms to a user.

18. The system of claim 14, wherein the semantically related term tool is further operative to export at least a portion of the determined plurality of terms to at least one of an Internet search engine and an online advertisement service provider.
